(19) United States
(12) Patent Application Publication
(10) Pub. No.: US 2004/0069546 A1
(43) Pub. Date: Apr. 15, 2004

(54) Hybrid electrical vehicle powertrain thermal control

(76) Inventors: Zheng Lou, Plymouth, MI (US); Peri Sabhapathy, Northville, MI (US)

Correspondence Address: Dickinson Wright PLLC, Suite 800, 1901 L. Street NW, Washington, DC, 20036, US

(21) Appl. No.: 10/271,420

(22) Filed: Oct. 15, 2002

(51) Int. Cl. B60K 11/00

(52) U.S. Cl. 180/65.2

(57) ABSTRACT

The powertrain thermal system of the present invention contains and/or utilizes various sensors and signals. Some are located within the powertrain thermal system itself. However, the majority are located in other systems of the hybrid electrical vehicle. The sensors used by the thermal system include an engine coolant temperature sensor, located at the outlet of the engine water jacket and contained within the existing engine control unit, a transmission fluid temperature sensor, located at the transmission fluid outlet of the liquid-liquid heat exchanger and contained within the transmission control unit, a motor coolant temperature sensor, located between the electric water pump and the inverter cold plate inlet and contained within the powertrain thermal control unit, a stator end-turn temperature sensor, located at the motor stator end-turn and contained within the motor-inverter control unit, a battery temperature sensor, located and contained within the battery control unit, a road speed sensor, contained within the powertrain supervisory control and an ambient temperature sensor, contained within the electronic climate control system. In addition, the present invention comprises a method of providing an optimum thermal environment in a hybrid electrical vehicle, comprising the steps of controlling a motor coolant temperature, controlling a stator end-turn temperature, controlling a transmission fluid temperature, de-rating electric power; and controlling an electric water valve.

### BACKGROUND OF THE INVENTION

This invention is related to the field of thermal control. More particularly, it is related to the field of powertrain thermal control. The instant invention provides a solution to the problem of optimizing the thermal environment for, a hybrid electrical vehicle's powertrain.

When a hybrid electrical vehicle is operated, its powertrain will generate heat. This heat can damage the various components of the powertrain such as the power electronics, the traction motor, the high voltage battery, the engine and the transmission.

### SUMMARY OF THE INVENTION

The invention comprises a method of providing an optimum thermal environment in a hybrid electrical vehicle, comprising the steps of controlling motor coolant temperature MCT, controlling stator end-turn temperature SET, controlling transmission fluid temperature TFT, de-rating electric power; and controlling an electric water valve EWV.

In another embodiment, the invention comprises a powertrain thermal system of a hybrid electrical vehicle, comprising a powertrain thermal control unit PTCU, a powertrain supervisory control unit PSC operably connected to the powertrain thermal control unit PTCU, a controller area network CAN link operably connected to the powertrain thermal control unit PTCU, an electronic climate control ECC system operably connected to the controller area network CAN link, a transmission control unit TxCU operably connected to the controller area network CAN link, a motor-inverter control unit MICU operably connected to the controller area network CAN link, an engine control unit ECU operably connected to the controller area network CAN link; and a battery control unit BCU operably connected to the controller area network CAN link.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 shows a logic block diagram of the hybrid electrical vehicle thermal management system;

FIG. 2 is a diagram of the powertrain thermal control unit's inputs and outputs;

FIG. 3 illustrates the states of the cooling fan control for motor coolant temperature regulation;

FIG. 4 is a MatLab/Simulink simulation model of the cooling fan logic control used in the present invention;

FIG. 5 illustrates the states of the motor coolant pump control;

FIG. 6 illustrates the states of motor power derating;

FIG. 7 illustrates the states of the water valve control;

FIG. 8 is a MatLab/SimuLink simulation model of the hybrid electrical vehicle;

FIG. 9 is a thermal circuit model;

FIG. 10 is an input of a simulation based on EPA city drive cycle in which vehicle speed is plotted vs. time;

FIG. 11 is a result of a simulation based on EPA city drive cycle in which fan duty cycle is plotted vs. time;

FIG. 12 is a result of a simulation based on EPA city drive cycle in which electric water pump speed is plotted vs. time;

FIG. 13 is a result of a simulation based on EPA city drive cycle in which power limiting factor is plotted vs. time;

FIG. 14 is a result of a simulation based on EPA city drive cycle in which motor coolant temperature is plotted vs. time;

FIG. 15 is a result of a simulation based on EPA city drive cycle in which stator end-turn temperature is plotted vs. time; and

FIG. 16 is a result of a simulation based on EPA city drive cycle in which transmission fluid temperature is plotted vs. time.

### DETAILED DESCRIPTION OF THE PREFERRED EMBODIMENT

Powertrain Thermal Circuit

In a hybrid electrical vehicle, the powertrain thermal system should provide an optimum thermal environment for power electronics, the traction motor, the high voltage (HV) battery HVB, the engine EG and the transmission TR. An example of a powertrain thermal system used in a hybrid electric vehicle is disclosed in co-pending patent application Ser. No. 10/036,056 entitled “Hybrid Vehicle Powertrain Thermal Management System And Method For Cabin Heating And Engine Warm Up,” filed Jan. 4, 2002, which is hereby incorporated by reference.

Sensors and Signals

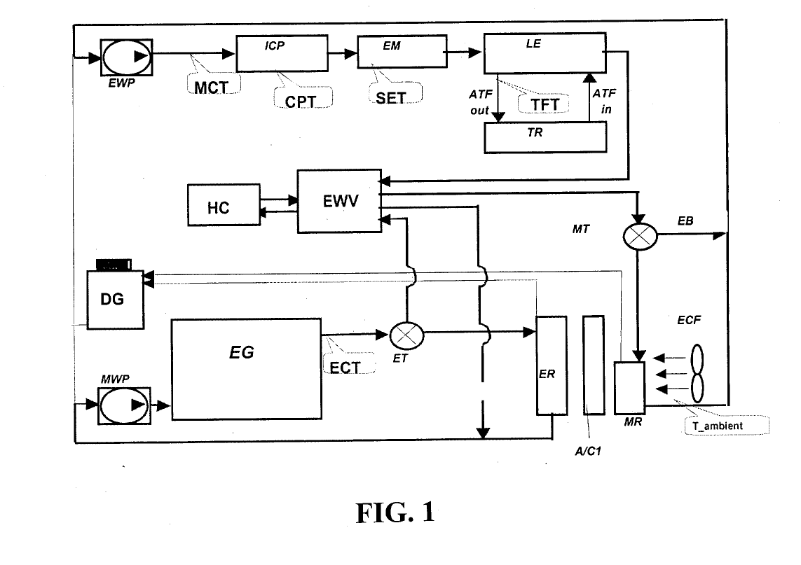

The powertrain thermal system contains and/or utilizes various sensors and signals. Some are located within the powertrain thermal system itself. However, the majority are located in other systems of the hybrid electrical vehicle. The locations of some of the sensors are also depicted within the cooling circuits of FIG. 1. These include the engine coolant temperature ECT sensor, the transmission fluid temperature TFT sensor, the motor coolant temperature MCT sensor, the stator end-turn temperature SET sensor and the ambient temperature T_ambient sensor.

The engine-driven mechanical water pump MWP circulates the engine coolant EC through the engine cooling system. The engine thermostat ET regulates the amount of engine coolant EC flow through the engine radiator ER and engine bypass EB, and thus helps shorten the engine's EG warm-up time and maintain the engine EG at an optimum operating temperature range. For the engine thermal circuit illustrated in FIG. 1, there is no explicit engine bypass EB, and the heater core HC sub-circuit doubles as the engine bypass EB. When the engine exit coolant is at less than the preset opening temperature (185 deg. F., for example), the engine thermostat ET outlet to the engine radiator ER is closed, and the engine coolant EC flows to the pump through the bypass EB. As the coolant temperature increases above the thermostat opening temperature, the engine thermostat ET outlet to the engine EG starts to open and is fully open when the coolant temperature is above a certain temperature (195 deg. F., for example). The portion of the engine coolant EC that flows through the engine radiator ER loses heat to the ambient air. Before entering the pump inlet, the portion of engine coolant EC flowing through the engine radiator ER and that flowing through the bypass EB mix together. The degas bottle DG with its pressure relief cap provides a continuous de-aeration for the cooling system.

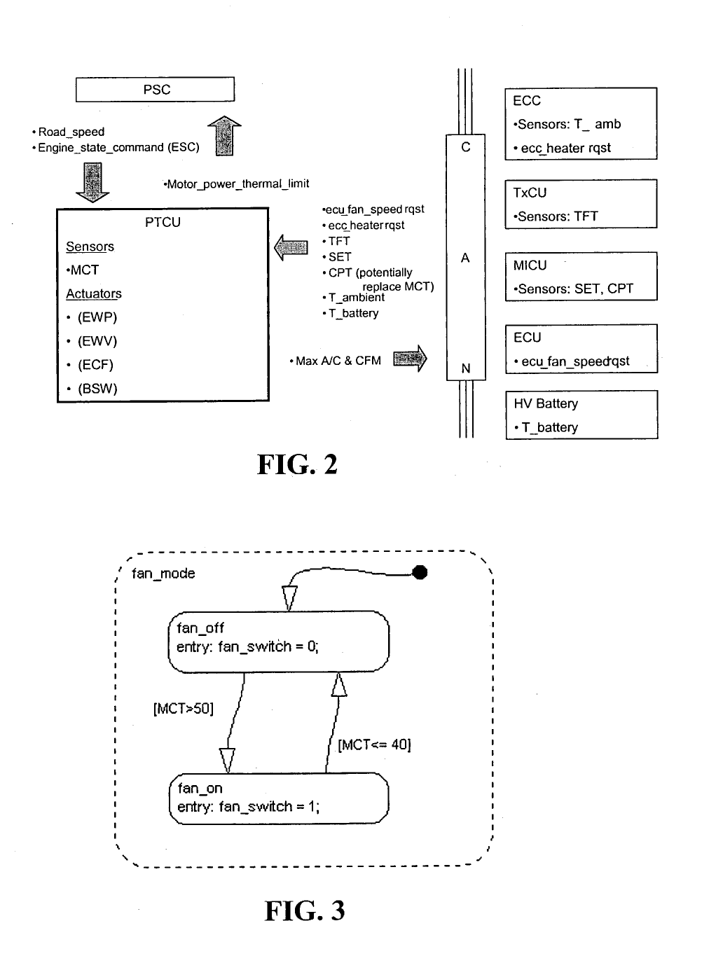

FIG. 2 illustrates the signal flow between the powertrain thermal control unit PTCU and the other control units contained within the thermal system. The sensors and signals include the following:

ECT (Engine Coolant Temperature) sensor, located at the outlet of the engine water jacket and contained within the existing engine control unit ECU.

TFT (Transmission Fluid Temperature) sensor, located at the outlet of the liquid-liquid heat exchanger LE and contained within the transmission control unit TxCU. It can also be located at the inlet of the transmission TR, or any place where temperature is substantially the same as that at the outlet of the liquid-liquid heat exchanger LE.

MCT (Motor Coolant Temperature) sensor, located between the electric water pump EWP and the inverter cold plate ICP inlet and contained within the powertrain thermal control unit PTCU. It can also be installed on the cold plate ICP, at the cold plate ICP inlet, or inside the cold plate ICP flow channel.

SET (Stator End-turn Temperature) sensor, located at or substantially close to the motor stator end-turn and contained within the motor-inverter control unit MICU.

Battery Temperature sensor, one or more of which is located and contained within the battery control unit BCU.

Road_speed sensor, contained within the powertrain supervisory control PSC.

T_ambient (Ambient Temperature) sensor, contained within the electronic climate control system ECC.

As shown Table 1 and in FIG. 2, the powertrain thermal control unit PTCU receives and uses numerous signals from sensors contained in various control units and in the powertrain thermal control unit PTCU. For example, the powertrain thermal control unit PTCU obtains the road_speed signal and the engine_state_command signal directly from sensors contained in the powertrain supervisory control PSC. The road_speed signal is indicative of the speed at which the vehicle is traveling. Table 1 provides details about the road_speed signal along with other signals. For example, road speed is measured in units of m/s with a range of 0 to 45 m/s. It is a digital signal which is sampled every 20 seconds. Furthermore, it is delivered from the powertrain supervisory control PSC to the powertrain thermal control unit PTCU.

The powertrain thermal control unit PTCU receives both the ambient temperature signal T_ambient and the heater request signal ecc_heater_rqst from the electronic climate control ECC through the controller area network CAN link. In addition, the PTCU receives through the CAN link the transmission fluid temperature signal TFT from the transmission control unit TxCU. In addition, the powertrain thermal control unit PTCU receives through the CAN link both the stator end-turn temperature SET signal and the cold plate temperature CPT signal from the motor-inverter control unit MICU, the engine control unit fan request signal ecu_fan_speed_rqst from the engine control unit ECU, and the battery surface temperature signal T_battery from the high voltage (HV) battery HVB. Furthermore, the powertrain thermal control unit PTCU is directly linked to the motor coolant temperature MCT sensor.

The powertrain thermal control unit PTCU uses all these inputs to control the operation of the electric water pump EWP, the electric water valve EWV, the electric cooling fan ECF, and battery air intake switch BSW. The battery cooling air control can be one of many disclosed in the prior art.

The powertrain thermal control unit PTCU proactively issues a motor_power_thermal_limit signal to the powertrain supervisory control PSC based on the thermal states of the system. When necessary, the powertrain thermal control unit PTCU instructs the electronic climate control ECC to provide maximum A/C from the A/C Condenser A/Cl and air flow (measured in cubic feet per minute) for the battery cooling system to draw the cooled air from the cabin. Table I tabulates the details of all the signals, such as their resolutions and sample periods.

TABLE 1
Signal Details

| | | | | | | | | | Sample |
|---|---|---|---|---|---|---|---|---|---|
| | | | | Signal | | | | | Period |
| Signal Name | Unit | In/Out | Connect | Type | From | To | Resolution | Range | [sec] |
| Road_speed | m/s | IN | PSC | Digital | PSC | PTCU | 1 | 0 to 45 | 20 |
| Engine_state_command | N/A | IN | PSC | Digital | PSC | PTCU | N/A | N/A | 20 |
| Motor_power_thermal_limit | W | OUT | PSC | Digital | PTCU | PSC | 1,000 | 40,000 | 5 |
| Ecc_heater_request | C | IN | CAN | Digital | ECC | PTCU | N/A | N/A | 20 |
| TFT (transmission fluid T) | C | IN | CAN | Digital | T×CU | PTCU | 2 | −40 to +150 | 20 |
| SET (stator end-turn T) | C | IN | CAN | Digital | MICU | PTCU | 2 | −40 to +200 | 5 |
| CPT (cold plate T) | C | IN | CAN | Digital | MICU | PTCU | 2 | −40 to +100 | 5 |
| T_ambient | C | IN | CAN | Digital | ECC | PTCU | 1 | −40 to +50 | 20 |
| ECT (engine coolant T)) | rpm | IN | CAN | Digital | ECU | PTCU | 2 | −40 to +130 | 20 |
| Ecu_fan_speed_rqst | N/A | IN | CAN | Digital | ECU | PTCU | N/A | 0/Low/High | 20 |
| T_battery (battery T) | rpm | IN | CAN | Digital | Battery | PTCU | 1 | −40 to +100 | 5 |
| EWP speed | C | OUT | Local | Analog | PTCU | EWP | 100 | 6000 | 5 |
| EWV status (on or off) | N/A | OUT | Local | Analog | PTCU | EWV | On/off | On/off | 5 |
| Cooling_fan_speed_motor | rpm | OUT | Local | Analog | PTCU | Fan | N/A | 0/Low/High | 20 |
| MCT (motor coolant temp) | C | IN | Local | Analog | MCT | PTCU | 2 | −40 to +110 | 20 |
| | | | | | sponsor | | | | |

Control Strategy

The following is a description of the methods used to control the temperatures of the different components of the hybrid electric vehicle HEV engine. These components include the inverter cold plate ICP, the electric motor EM, the liquid-liquid heat exchanger LE, and the electric water valve EWV.

Inverter Cold Plate

The inverter comprises electronics which are used to convert the voltage of a DC battery or batteries into an AC signal for use by the motor and vice versa. In the inverter cold plate ICP, it is preferred that the transistor or junction temperature remains under 125 deg. C. Beyond this temperature, the performance of the electronics deteriorates. Furthermore, if the temperature goes beyond 175 deg. C., irreversible damage can occur to the electronics.

The cold plate ICP has a time constant of between 1 and 15 seconds, depending on the plate's design. Consequently, it is preferred that the motor coolant temperature MCT be kept below 50 deg. C. and the coolant flow rate should remain at or above 0.1 L/s. When the temperature of the motor coolant temperature MCT rises above 50 deg. C., a motor power limit will be activated to reduce the heat generation in proportion and to the extent that the temperature is above this 50 deg. C. limit.

Either the temperature limit or the motor power limit can be adjusted based on the motor coolant flow rate. A higher coolant flow rate can improve convection heat transfer between the motor coolant and the cold plate. A cold plate temperature CPT sensor can also be used to assist in the control of the inverter transistor temperature. However, its effectiveness can be adversely influenced by the spatial and dynamic variation of the temperature in the plate.

Electric Motor

In the electric motor EM , it is preferred that the stator end-turn temperature SET remains under 180 deg. C. Beyond this temperature, irreversible damage can occur to the coil insulation. In the stator, the stator end-turns operate at the highest temperature because they are not surrounded by a good heat transfer medium.

Although it is generally believed that there is no substantial heat generation in a rotor of a permanent magnetic electric motor, the thermal state of the rotor is still monitored for the following two reasons:

(1) While the overall heat generation may be low, there may be still some local hot spots especially around the magnets, which are temperature sensitive.

(2) The rotor or motor torque is strongly related to the magnet's temperature. Therefore, dynamic information on magnet temperature is needed in order to operate a motor smoothly. In a preferred embodiment, the rotor temperature is extrapolated from the stator end-turn temperature SET.

Liquid-Liquid Heat Exchanger

In the liquid-liquid heat exchanger LE, it is preferred to keep the transmission fluid temperature TFT within an operating range of 40 to 80 deg. C., with a target of 60 deg. C. The temperature range and target are generally application dependent and their values used here are lower than normal for two reasons: (1) the transmission used in the particular system associated with this invention is a continuously variable transmission (CVT) that is more sensitive to temperature and (2) lower temperatures are possible in this particular system because of the use of the liquid-to-liquid heat exchanger LE, where the cooling medium is at the motor coolant temperature MCT, which is much lower than the engine coolant temperature ECT. For a traditional powertrain, the transmission fluid dumps heat to the engine coolant.

The transmission fluid has different temperatures at different locations within the transmission TR. In this thermal circuit, the transmission fluid temperature TFT is defined as the transmission fluid temperature at the exit of the liquid-liquid heat exchanger LE which feeds the cooled fluid into various circuits, not the sump.

However, it is expected that the transmission fluid is at much higher temperatures inside the transmission oil sump and at the return lines of the continuously variable unit, the lubrication circuit, and the clutch circuit.

The transmission fluid viscosity is generally more temperature sensitive than that of the viscosity of the coolant. It is preferred that the transmission fluid temperature TFT stays within a reasonable range for smooth control and efficiency. Although it is preferable that the transmission fluid temperature TFT stay within a range of 40 to 80 deg. C., some deviation outside this range will not result in irreversible damage nor dysfunction. For example, when operating the hybrid electric vehicle HEV during a cold winter morning, the transmission fluid temperature TFT may remain below 40 deg. C. most of, if not all, the time during a short trip.

Electric Water Valve

The electric water valve EWV is normally in an “off” position. In this position, the engine coolant will pass through the heater core HC, while the motor coolant passes straight through the electric water valve EWV and back to the motor cooling circuit.

The electric water valve EWV is switched to an “on” position if the following three conditions are all true:

1. The engine EG is off,

2. There is a need for heating; and

3. The motor coolant is reasonably warm.

When the electric water valve EWV is on, the motor (not engine) coolant passes through the heater core while the engine (not motor) coolant passes straight through the valve and back to the engine cooling circuit.

Control Details

The method of the present invention provides an optimum thermal environment in a hybrid electrical vehicle HEV by controlling the motor coolant temperature MCT, the stator end-turn temperature SET, the transmission fluid temperature TFT, the electric water valve EWV and de-rating electric power.

Motor Coolant Temperature (MCT) Control

The motor coolant temperature MCT is controlled based on the following limits and target:

MCT1=30 deg. C. Lower limit

MCT2=40 deg. C. Target

MCT3=50 deg. C. Upper limit

Furthermore, the motor coolant temperature MCT is controlled using the following three mechanisms, the motor thermostat MT temperature setting, the cooling fan ECF, and the motor coolant flow rate QW.

Motor thermostat MT temperature setting: The motor thermostat MT is set to be fully closed and allows no coolant through the motor radiator until MCT=MCT1. Then, the thermostat MT gradually opens as the motor coolant temperature MCT increases until MCT=MCT2, when the thermostat is fully open.

Electric Cooling Fan ECF: Under normal vehicle speeds, environmental conditions, and heat generation, the motor radiator MR is sufficient to dissipate heat. However, if the MCT rises above MCT3, the cooling fan can be turned on to make sure that MCT<MCT3. This situation can occur especially at zero or low vehicle speeds.

Because of the transport delay and system inertia, the fan control cannot be operated on a single temperature point. Therefore, to avoid busy on/off action and associated noises and interruptions, it should be operated over an operating temperature band. FIG. 3 illustrates the use of the operating band MCT2 TO MCT3. When the motor coolant temperature MCT is equal to or below 40 deg. C., the fan_switch control signal is set to 0, turning the fan off. When the motor coolant temperature MCT rises above 50 deg. C., the fan_switch control signal is set to 1, turning the fan on.

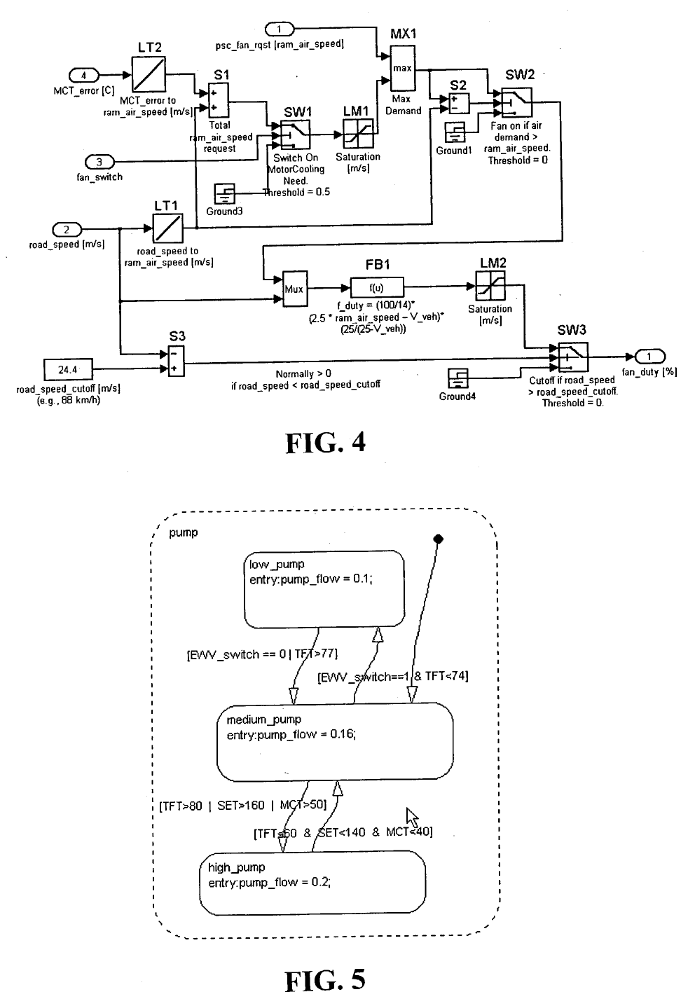

Use of the same electric cooling fan ECF will also impact the engine radiator ER temperature as well as the motor radiator MR temperature. Assuming that overheating is more dangerous than overcooling, a maximum temperature logic control is used to accommodate the highest cooling demand either from the motor circuit or the engine circuit as shown in FIG. 4.

Description of FIG. 4

In FIG. 4, psc_fan_rqst represents the cooling fan demand signal from the engine cooling circuit. The psc_fan_rqst signal comes from the Powertrain Supervisory Controller PSC, which in turn receives the cooling demand from the engine control module ECM. Signal 1, the psc_fan_rqst signal, is input to logic chip MX1, which calculates and outputs the maximum value of all the input signals.

Also shown in FIG. 4 is additional logic circuitry used to measure vehicle speed or ram air speed. For example, Signal 2, the vehicle speed, road_speed, is input to a look-up table LT1 which converts road_speed to ram_air_speed. Ram_air_speed refers to the air passing through the cooling assembly at the front of the vehicle. Ram_air_speed is generally only a fraction, e.g. 40%, of the road speed because of the aerodynamic resistance. Look-up table LT1 may simply multiple the input by a factor, say 0.4, or perform more sophisticated mathematical conversion. The output of LT1, ram_air_speed, is input to summer S1 and summer S2.

Signal 3, fan_switch, controls switch SW1. Switch SW1 has three inputs, numbered from the top to the bottom. It passes through input 1 when input 2 is equal or greater than a threshold (assigned, within the block, to be 0.5 in this case); otherwise passes through input 3. In this case, when fan_switch is on or equal to 1, the output is equal to input from summer S1; otherwise the output is grounded or 0.

Signal 4, the motor coolant temperature error signal MCT_error, is the input of look-up table LT2, which translates MCT_error into a ram_air_speed request signal. In this case, it performs 1-D linear interpolation of input values using the specified table. Extrapolation is performed outside the table boundaries. One can demand, for example, a ram_air_speed of 24.4×0.4 m/s when MCT_error is equal to 10 deg. C. The output of LT2 is input to summer S1. Summer S1 calculates the total ram_air_speed request signal which is input 1 of switch SW1.

In FIG. 4, switch SW1 is connected to the total ram_air_speed request signal. This signal is passed by switch SW1 to limiter LM1. Limiter LM1 passes the total if its value is within an upper and a lower threshold. The output value of the limiter LM1 is clamped to the upper threshold (e.g., 24.4×0.4 m/s) if the total ram_air_speed request signal exceeds the upper threshold.

Similarly, the output voltage of limiter LM1 is clamped to the lower threshold (e.g., 0 m/s) if the total ram_air_speed request signal is less than the lower threshold. The output of limiter LM1 is input 2 of logic chip MX1. The output of MX1 is the air demand signal. This signal is input 1 to switch SW2 and also to summer S2.

The cooling effect of the cooling fan diminishes at higher vehicle speeds. Thus, the fan is either tuned down or turned off at higher vehicle speeds. The additional logic shown in FIG. 4 uses variable speed or variable duty cycle to control fan speed.

The output of summer S2 is used to control switch SW2, which functions logically the same way as switch SW1 does and has a threshold value of 0. Summer S2 outputs the difference between the air demand signal and the ram_air_speed signal. The fan is turned on if the air demand signal is greater than the ram_air_speed signal. This is illustrated in FIG. 4 where switch SW2 is connected to the air_demand signal. This signal is passed by switch SW2 to multiplexer MUX.

The output of multiplexer MUX is input to function block FB1 which calculates the fan duty cycle fan_duty for the cooling fan, using the formula

f_duty=(100/14)*(2.5*ram_air_speed−road_speed)*(2.5/(25*road_speed)).

Fan speed can be varied or modulated by varying the duty cycle. This pulse-width-modulated signal is then passed through limiter L2 to switch SW3, which functions logically the same way as switch SW1 does and has a threshold value of 0.

Signal 2, the road_speed signal, is one input of summer S3. The other input of summer S3 is signal road_speed_cutoff, which references a road speed (e.g. 88 km/h or 24.4 m/s) at which the resulting ram air speed is so overwhelming that the effectiveness of the cooling fan is almost diminished. The output of summer S3 is used to control switch SW3. The output of summer S3 is normally greater than 0 if the road_speed is less than the road_speed_cutoff. This is illustrated in FIG. 4 where switch SW3 is connected to the signal fan_duty which is used to control the fan speed.

If the road_speed is greater than the road_speed_cutoff, then switch SW3 is switched to ground, producing a 0% duty cycle control signal and turning the fan off. As stated supra, the cooling effect of the cooling fan diminishes at higher road speeds. Thus, the fan is turned off at higher road speeds.

The cooling fan logic can be implemented using Pulse Width Modulation (PWM) or other similar means. When a simple on/off fan is used to simply turn the fan off at higher speeds, the logic can be simplified accordingly.

Coolant flow rate: An increase in coolant flow rate helps reduce the motor coolant temperature MCT. It also helps increase the convection heat transfer in both the inverter and motor, thus making the system more tolerant of higher values for motor coolant temperature MCT. The control logic is depicted in FIG. 5.

Stator End-Turn Temperature (SET) Control

The stator end-turn temperature (SET) is controlled using the following limits and targets:

SET1=140 deg. C. Threshold for normal motor coolant flow rate

SET2=160 deg. C. Threshold for high motor coolant flow rate & de-rating.

SET3=180 deg. C. Maximum SET value allowed.

Control of the Motor Coolant Flow Rate QW

The stator end-turn temperature SET is controlled by controlling the motor coolant flow rate QW. The motor coolant temperature MCT has a direct influence on the stator end-turn temperature SET, and its limits and target are selected primarily for the proper operation of the inverter ICP and, to a certain degree, the proper operation of the transmission TR. Within the limits of the motor coolant temperature MCT, the motor cooling channel is designed to handle most, if not all, of the heat dissipation conditions. The motor coolant flow rate QW is normally kept around 0.16 Liter/second for one particular hybrid electrical vehicle HEV thermal system. When needed (for example when the stator end-turn temperature SET>SET2 as shown in FIG. 5, the coolant flow rate QW can be set at a higher rate flow rate (say 0.2 Liter/second) to enhance convection heat transfer and reduce temperature rise within the motor cooling channels. To avoid frequent switching, the coolant flow rate QW is kept at the higher flow rate until the stator end-turn temperature SET falls below SET1, that is 140 deg. C. When there is a need for cabin heating with the motor coolant (i.e., with the electrical water valve EWV on) and when the transmission fluid temperature TFT is not warm enough, the motor coolant flow rate QW can be artificially kept low (say 0.1 Liter/second, see FIG. 5) to boost transmission fluid temperature TFT and the motor coolant exit temperature out of the liquid-to-liquid heat exchanger LE.

Transmission Fluid Temperature (TFT) Control

Transmission fluid temperature TFT is controlled using the following limits and target:

TFT1=40 deg. C. Lower limit

TFT2=60 deg. C. Target point

TFT3=80 deg. C. Upper limit

The lower limit TFT1 is set as a minimum threshold for the fast warm-up of the transmission fluid to avoid heavy friction loss and sticky shifting associated with low oil temperature and high viscosity. The target point TFT2 is estimated to be the ideal oil temperature. The upper limit TFT3 is the upper limit. In this case, 80 deg. C. is a conservative limit. Occasional operations beyond TFT3 will not cause substantial adverse impact on the transmission life. To accommodate the cabin heating needs, it may be preferred to set TFT3 at a higher value (say 90 deg. C.) when the electrical water valve EWV is on, which implies the vehicle is circulating the motor coolant through the heater core HC.

The transmission fluid temperature TFT is controlled using the following mechanisms: a proper range for motor coolant temperature MCT and control of the coolant flow rate QW.

Setting a proper range for the motor coolant temperature MCT: Motor coolant temperature MCT has a large effect on the transmission fluid temperature TFT due to the fact that the motor coolant MC and the automatic transmission fluid ATF undergoing a fairly effective heat transfer in the liquid-liquid heat exchanger LE. Thus, the motor coolant temperature's MCT limits and target are selected to control the transmission fluid temperature TFT. In addition, the motor coolant temperature MCT is used to control the inverter cold plate's ICP temperature which can be a weak link in the system. The motor coolant MC is at a higher temperature when reaching the liquid-to-liquid heat exchanger LE because of thermal energy accumulated at both the inverter cold plate ICP and the electric motor EM. Thus, the need for transmission fluid temperature TFT control and the amount of heat generation in the circuit are considered when defining the limits and target for the motor coolant temperature MCT. The transmission fluid temperature TFT is affected by other factors, such as the heat generation in other parts of the circuit such as the transmission TR, the motor coolant flow rate QW, the oil pump flow rate and oil usages within various sub-circuits within the transmission TR.

Control of the motor coolant flow rate QW: The second mechanism used to control the transmission fluid temperature TFT is the motor coolant flow rate QW. In the liquid-liquid heat exchanger LE, a higher motor coolant flow rate QW value can reduce the coolant inlet temperature and enhance heat rejection from the transmission fluid, thus lowering the transmission fluid temperature TFT value. During the warm up, the coolant flow rate QW is kept at a low value of 0.1 Liter/second until TFT is increased from a normal rate of 0.16 Liter/second to 0.20 Liter/second when the transmission fluid temperature TFT>TFT3 and switched back to the normal rate of 0.16 Liter/second when the transmission fluid temperature TFT is reduced back to TFT2 as shown in FIG. 5.

Electric Power De-rating

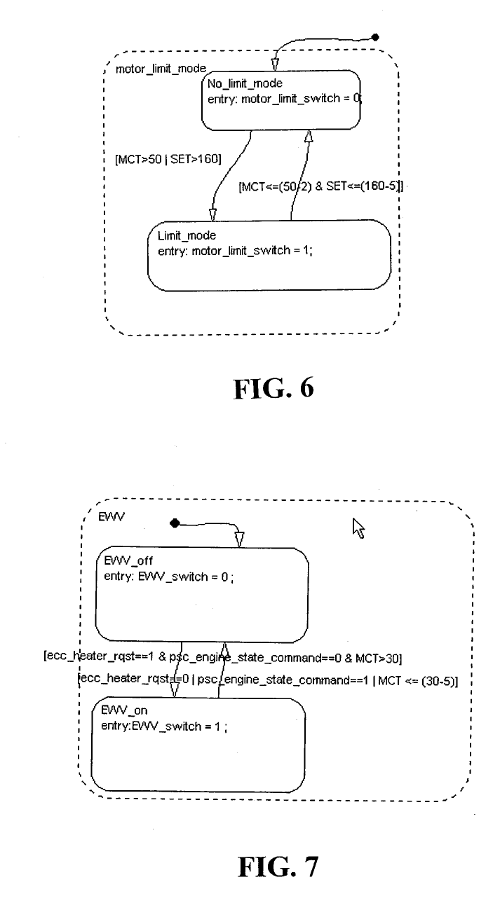

Electric power de-rating is used to reduce the power level in the electric circuit to avoid overheating the inverter cold plate ICP and/or the electric motor EM. This can occur in situations where the motor coolant temperature MCT>MCT3 (say 50 deg. C.) and/or the stator end-turn temperature SET>SET2 (say 160 deg. C.) as shown in FIG. 6.

During de-rating, the powertrain supervisory controller PSC may allow the same amount of total power demanded by the driver through assigning more output from the engine EG. As a result, the transmission TR may experience the same amount of heat generation during de-rating. However, the present invention protects the transmission from heat generated by high power levels by including high thermal inertia and generous design tolerance. Therefore, there is no need to de-rate for transmission TR protection.

Electric Water Valve Control

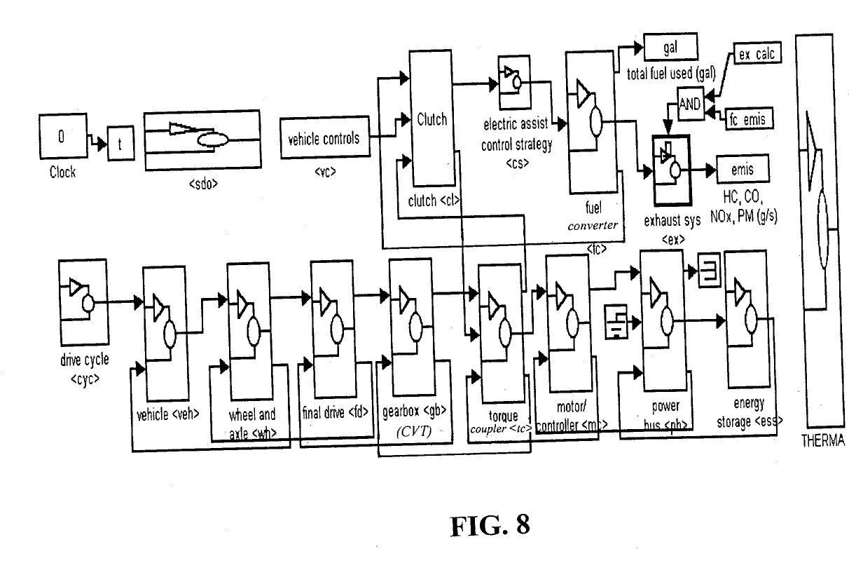

Normally, the electric water valve EWV is off. In this position the engine coolant is circulated through the heater core HC via the electric water valve EWV, while the motor coolant is isolated from the heater core HC. On the other hand, when electric water valve EWV is on, the valve EWV circulates the coolant for the motor cooling circuit, instead of that from the engine cooling circuit, to the heater core HC. The electric water valve EWV is switched on when there is request for heat, the engine EG is on, and the motor coolant is sufficiently warm as shown in FIG. 7.

Alternative Control Algorithm

The control strategies discussed so far are generally implemented discretely from one state to another as depicted in FIGS. 3, 4 and 5. They are not limited so and can be, alternatively, implemented continuously. The change from medium_pump to high_pump states in FIG. 5, for example, can be implemented as follows:

Let

| | | |
|---|---|---|
| dTFT = | 0 | If TFT < 60 deg. C. |
| | 1 | If TFT > 80 deg. C. |
| | (TFT-60)/(80-60) | Otherwise |
| dSET = | 0 | If SET < 140 deg. C. |
| | 1 | If SET > 160 deg. C. |
| | (SET-160)/(180-160) | Otherwise |
| dMCT = | 0 | If MCT < 40 deg. C. |
| | 1 | If MCT > 50 deg. C. |
| | (SET-40)/(50-40) | Otherwise |

And control the pump flow as calculated below,

Pump_flow=0.16+Minimum{(dTFT+dSET+dMCT), 1}(0.20−0.16)

With a brushless coolant pump, it is not difficult to control the flow rate continuously.

Simulation Results

The control strategy discussed above is used in a HEV MatLab/SimuLink simulation model. This model includes a thermal circuit as well as models of hardware and control strategies for the rest of the vehicle as shown in FIG. 8.

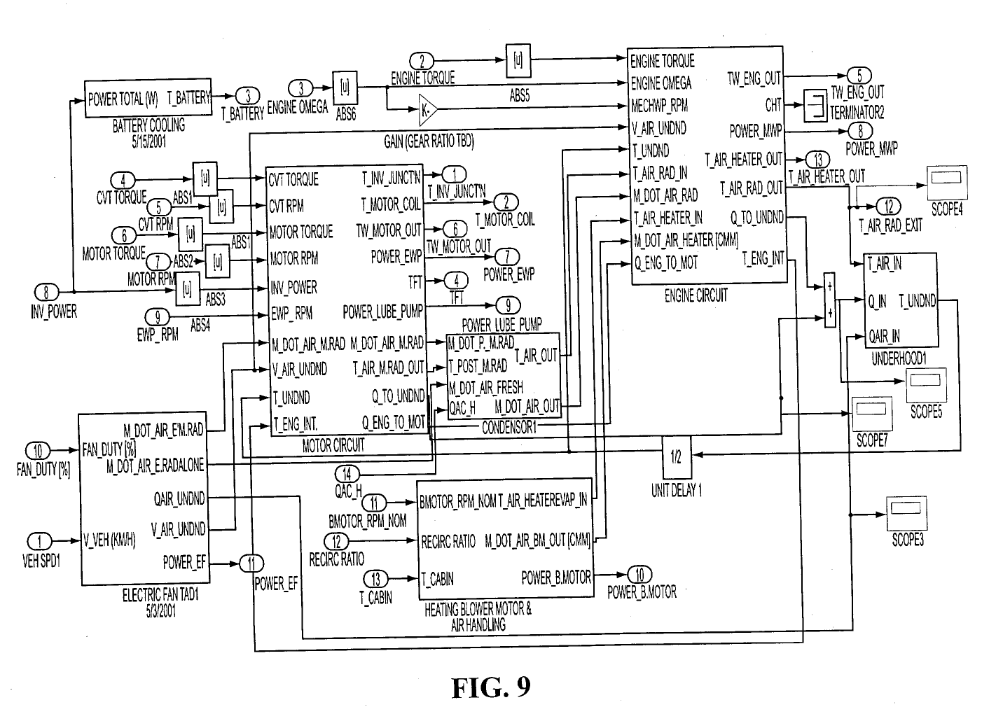

The thermal circuit further includes the motor circuit, engine circuit, and certain elements of the HVAC, the front cooling, and underhood systems to tie the engine and motor circuits together as shown in FIG. 9. The thermal circuit in the simulation model does not yet include the electric water valve EWV.

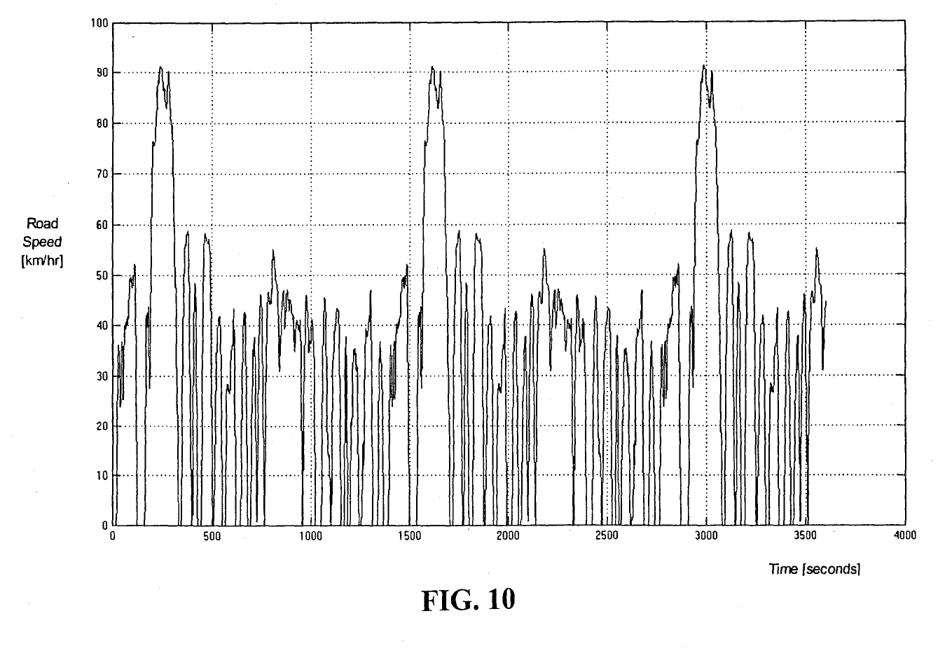

Simulations are driven by various vehicle drive cycles and under prescribed environmental conditions. What follows are some results of a simulation based on EPA city drive cycle (see FIG. 10) at an ambient temperature of 20 deg. C. and on a flat road.

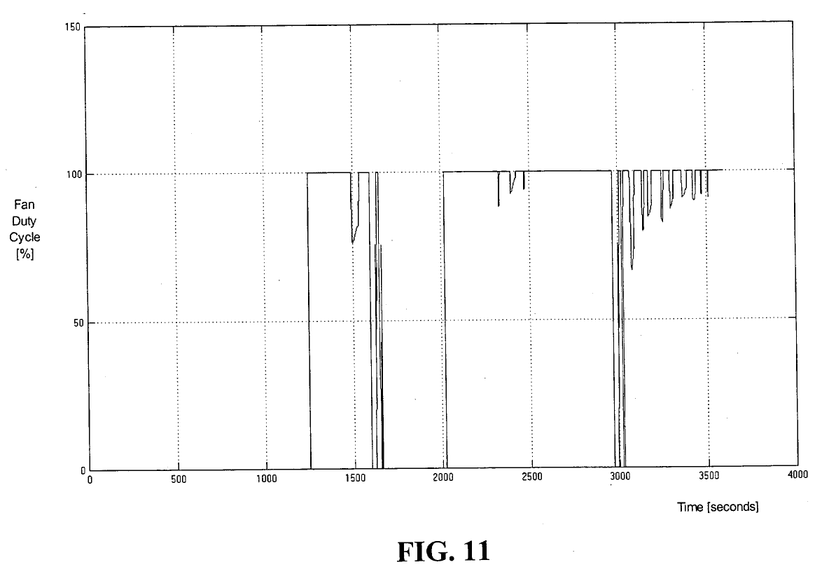

Because of the overall slow moving nature of the drive cycle, the electric fan ECF is turned on about 40% of the time during the 1-hr period as shown in FIG. 11. In this case, the fan is controlled with a variable duty cycle.

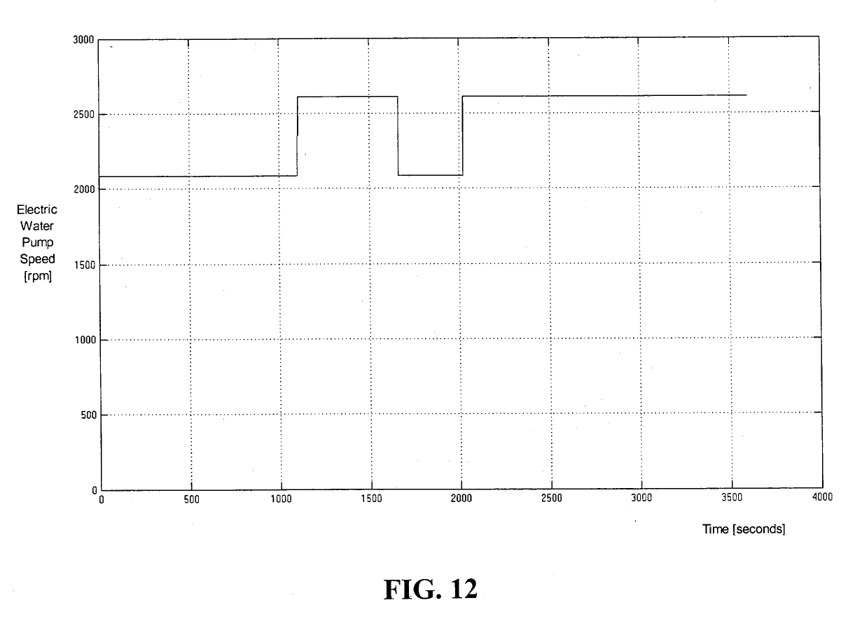

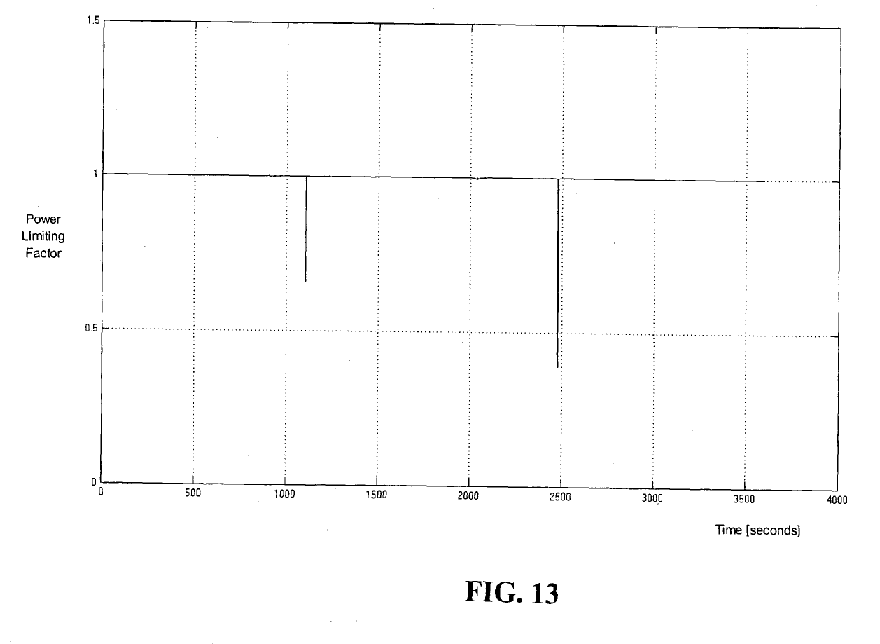

During the warm up, the electric water pump EWP is operated at the medium pump speed (as shown in FIG. 12), which gives a flow rate of 0.16L/s. During the rest of the drive cycle, it is operated mostly at the high pump speed, which gives a flow rate of 0.2 L/s. It is not operated at the low pump speed because of the moderate temperature conditions and minimum use of the electric water valve EWV in the current simulation model. FIG. 13 discloses the power limiting factor.

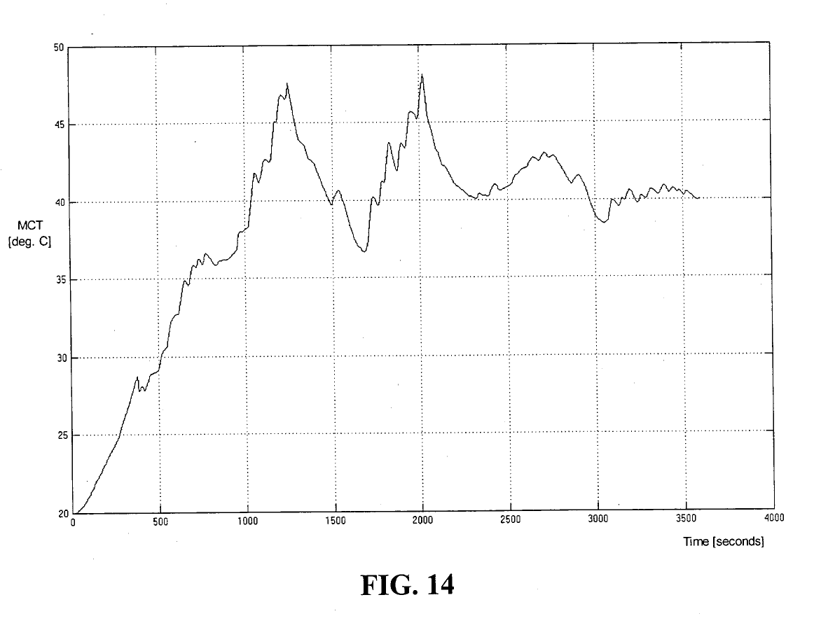

After the initial warm-up, the motor coolant temperature MCT remains inside the desired range of 30 and 50 deg. C. and around the target temperature of 40 deg. C. (see FIG. 14).

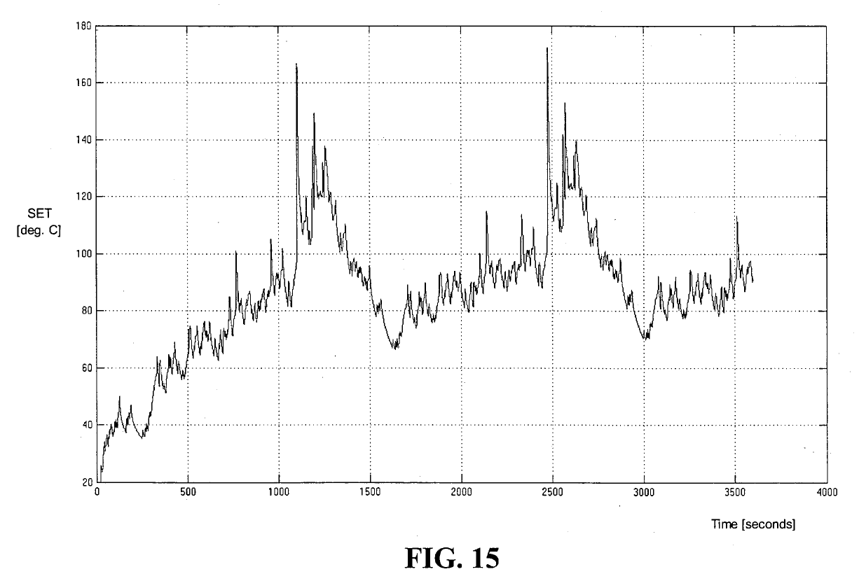

The motor stator end-turn temperature SET remains under the maximum limit of 180 deg. C. (see FIG. 15). It twice exceeds the 160 deg. C., threshold for high coolant flow rate and the motor power de-rating. The corresponding de-rating happens at around 1,100 and 2,500 seconds (see FIG. 13). Also at 1,100 seconds, the pump changes from operating at the medium speed to high speed as shown in FIG. 12. At 2,500 seconds, the pump is already operating at the high speed, which is triggered by a peaky motor coolant temperature MCT at around 2,000 seconds as shown in FIGS. 12 and 14.

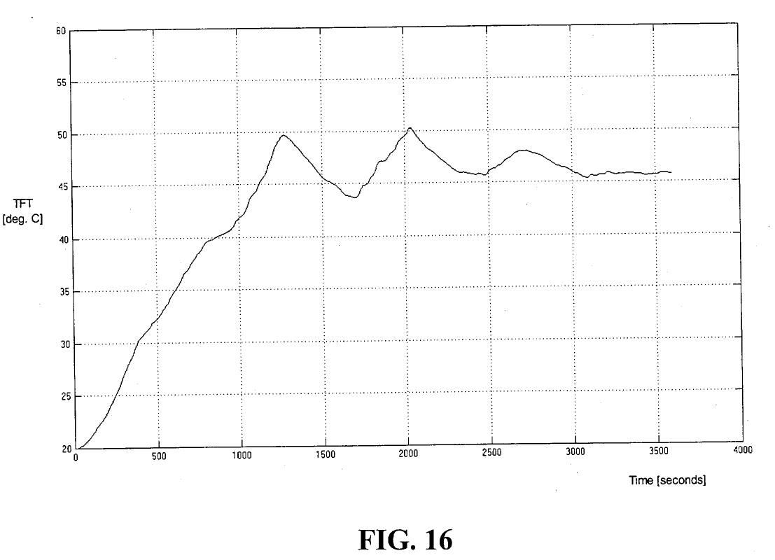

After the initial warm-up, the transmission fluid temperature TFT (see FIG. 16) remains around 45 to 50 deg. C. well within the limits of 40 and 80 deg. C. This is below the target temperature of 60 deg. C. With higher vehicle loads and hotter environmental conditions, it may move closer to the target temperature. It can also be regulated by adjusting design parameters of the liquid-liquid heat exchanger LE.

The present invention comprises a set of innovative yet simple and robust control strategies for a unique HEV thermal control system. The effectiveness of the strategy has been proven in numerical simulations. While the invention has been disclosed in this patent application by reference to the details of preferred embodiments of the invention, it is to be understood that the disclosure is intended in an Illustrative rather than in a limiting sense, as it is contemplated that modification will readily occur to those skilled in the art, within the spirit of the invention and the scope of the appended claims and their equivalents.

What is claimed is:

1. A method of providing an optimum thermal environment in a hybrid electrical vehicle, comprising the steps of:
controlling a motor coolant temperature;
controlling a stator end-turn temperature;
controlling a transmission fluid temperature;
de-rating electric power; and
controlling an electric water valve.

2. The method according to claim 1, wherein said step of controlling said motor coolant temperature comprises:
controlling a motor thermostat temperature setting, a cooling fan, and a motor coolant flow rate.

3. The method according to claim 1, wherein said step of controlling said stator end-turn temperature comprises controlling a motor coolant flow rate.

4. The method according to claim 1, wherein said step of controlling a transmission fluid temperature comprises setting a range for a motor coolant temperature and controlling a motor coolant flow rate.

5. The method according to claim 1, wherein said step of controlling an electric water valve comprises:
circulating engine coolant through a heater core via an electric water valve when said electric water valve is off; and
circulating motor coolant to said heater core when said electric water valve is on.

6. The method according to claim 2, wherein said step of controlling said motor thermostat temperature comprises the steps of:
fully closing a motor thermostat, whereby no motor coolant flows through a motor radiator until said motor coolant temperature reaches a lower temperature limit; and
gradually opening said motor thermostat as said motor coolant temperature increases until said motor coolant temperature reaches a target temperature, whereby said motor thermostat is fully open.

7. The method according to claim 2, wherein said step of controlling said cooling fan comprises turning on said cooling fan if said motor coolant temperature rises above an upper limit.

8. The method according to claim 3, further comprising setting said motor coolant flow rate higher, whereby convection heat transfer is enhanced and temperature rise is reduced within motor cooling channels.

9. The method according to claim 4, wherein said step of controlling a motor coolant flow rate comprises increasing said motor coolant flow rate when said transmission fluid temperature is greater than an upper limit; and switching said motor coolant rate to normal when said transmission fluid temperature is reduced.

10. The method according to claim 6, wherein said step of controlling said stator end-turn temperature comprises controlling a motor coolant flow rate; wherein said step of controlling said transmission fluid temperature comprises setting a range for said motor coolant temperature and controlling said motor coolant flow rate; and wherein said step of controlling an electric water valve comprises circulating engine coolant through a heater core via said electric water valve when said electric water valve is off; and circulating said motor coolant to said heater core when said electric water valve is on.

11. The method according to claim 7, wherein said step of controlling said cooling fan comprises turning down said cooling fan at higher vehicle speeds.

12. The method according to claim 10, wherein said step of controlling said cooling fan comprises turning on said cooling fan if the motor coolant temperature rises above an upper limit; and
wherein said step of controlling a motor coolant flow rate comprises increasing said motor coolant flow rate when said transmission fluid temperature is greater than an upper limit; and switching said motor coolant rate to normal when said transmission fluid temperature is reduced.

13. The method according to claim 11, wherein said step of turning down said cooling fan comprises using variable speed or variable duty cycle to control fan speed.

14. A powertrain thermal system of a hybrid electrical vehicle, comprising:
a powertrain thermal control unit;
a powertrain supervisory unit operably connected to said powertrain thermal control unit;
an controller area network link operably connected to said powertrain thermal control unit;
an electronic climate control system operably connected to said controller area network link;
a transmission control unit operably connected to said controller area network link;
a motor-inverter control unit operably connected to said controller area network link;
an engine control unit operably connected to said controller area network link; and
a battery control unit operably connected to said controller area network link.

15. The powertrain thermal system according to claim 14, wherein said powertrain thermal control unit comprises a motor coolant temperature sensor, located between an electric water pump and an inverter cold plate;
wherein said powertrain supervisory unit comprises a road speed sensor; and
wherein said electronic climate control system comprises an ambient temperature sensor, whereby said powertrain thermal control unit receives both an ambient temperature signal and a heater request signal from said electronic climate control through said controller area network link.

16. The powertrain thermal system according to claim 14, wherein said transmission control unit comprises a transmission fluid temperature sensor located at the outlet of the liquid-liquid heat exchanger, whereby said powertrain thermal control unit receives through said controller area network link a transmission fluid temperature signal from said transmission control unit.

17. The powertrain thermal system according to claim 14, wherein said motor-inverter control unit comprises a stator end-turn temperature sensor located at the motor stator end-turn and contained within said motor-inverter control unit, whereby said powertrain thermal control unit receives through said controller area network link both a stator end-turn temperature signal and a cold plate temperature signal from said motor-inverter control unit.

18. The powertrain thermal system according to claim 14, wherein said engine control unit comprises an engine coolant temperature sensor located at an outlet of an engine water jacket, whereby said powertrain thermal control unit receives through said controller area network link an engine control unit fan request signal from said engine control unit.

19. The powertrain thermal system according to claim 14, wherein said battery control unit comprises a high voltage battery and at least one battery temperature sensor, whereby said powertrain thermal control unit receives through said controller area network link a battery surface temperature signal from said high voltage battery.

20. A powertrain thermal system of a hybrid electrical vehicle, comprising:
a powertrain thermal control unit comprising a motor coolant temperature sensor, located between an electric water pump and an inverter cold plate;
a powertrain supervisory unit operably connected to said powertrain thermal control unit and comprising a road speed sensor;
a controller area network link operably connected to said powertrain thermal control unit;
an electronic climate control system operably connected to said controller area network link, comprising an ambient temperature sensor, whereby said powertrain thermal control unit receives both an ambient temperature signal and a heater request signal from said electronic climate control through said controller area network link;
a transmission control unit operably connected to said controller area network link, comprising a transmission fluid temperature sensor located at the outlet of the liquid-liquid heat exchanger, whereby said powertrain thermal control unit receives through said controller area network link a transmission fluid temperature signal from said transmission control unit;
a motor-inverter control unit operably connected to said controller area network link, comprising a stator end-turn temperature sensor located at the motor stator end-turn and contained within said motor-inverter control unit, whereby said powertrain thermal control unit receives through said controller area network link both a stator end-turn temperature signal and a cold plate temperature signal from said motor-inverter control unit;
an engine control unit operably connected to said controller area network link and comprising an engine coolant temperature sensor located at an outlet of an engine water jacket, whereby said powertrain thermal control unit receives through said controller area network link an engine control unit fan request signal from said engine control unit; and
a battery control unit operably connected to said controller area network link, comprising a high voltage battery and at least one battery temperature sensor, whereby said powertrain thermal control unit receives through said controller area network link a battery surface temperature signal from said high voltage battery.
